(19) United States
(12) Patent Application Publication
(10) Pub. No.: US 2001/0045742 A1
(43) Pub. Date: Nov. 29, 2001

(54) Ticket with scratch-off area and method

(75) Inventor: Kirk Schulz, Milford, OH (US)

Correspondence Address: Gregory J Lunn, Wood Herron & Evans LLP, 2700 Carew Tower, 441 Vine Street, Cincinnati, OH, 45202-2917, US

(73) Assignee: schulz

(21) Appl. No.: 09/535,201

(22) Filed: Mar. 27, 2000

(51) Int. Cl. B42D 15/00

(52) U.S. Cl. 283/94

(57) ABSTRACT

A scratch-off coating is provided on an advance admission ticket to increase the perceived value of advertising as well as to prevent counterfeiting. The ticket will include a scratch-off area which will have an anti-counterfeiting feature such as contrasting particles, optical brighteners, or an opaque ink border. This can be covered over a back-ad on a ticket to increase the perceived value of the ad.

### BACKGROUND

A major concern with virtually any type of ticket is counterfeiting. Lottery tickets, admission tickets, game tickets are all the subject of counterfeiting attempts. In particular, newer photocopying devices and computer printers and scanners have made it much easier to counterfeit many tickets. Intricate printing and color variations are no longer as effective in preventing copying.

Another aspect of certain tickets is advertisement. Admission tickets frequently contain advertisement often on the back side of the ticket and therefore commonly referred to as back-ads. Normally these back-ads are in the form of coupons. Of course coupons are also the subject of counterfeiting attempts. An additional problem with back-ads is utilization. Normally only a very small percentage of these coupons are ever redeemed for merchandise. Most are simply discarded.

The present invention is premised on the realization that counterfeiting of tickets can be reduced by incorporating a scratch-off portion onto a ticket. Further, the utilization of a scratch-off portion to cover a coupon portion of a ticket and provide at the same time variable value coupons, will enhance the perceived value of the coupon on the ticket. This in turn will encourage greater utilization. Thus, the present invention can perform multiple functions.

More particularly the present invention is premised on the realization that a scratch-off area of a ticket can function as an anti-counterfeiting measure by incorporating metallic flakes into various layers of the scratch-off material. Thus when the scratch-off material is removed, metallic flakes remain on the ticket. Further the present invention is premised on the realization that such anti-counterfeiting scratch-off areas can be made wherein a release coating is applied over indicia and the opaque scratch-off ink is applied over the release coating but to an area larger than the release area. Thus, a portion of the opaque ink will not be removable from the ticket without destroying the ticket.

The present invention provides a wide variety of anti-counterfeiting measures and at the same time can be used to encourage someone to redeem a coupon which is part of a back-ad of a ticket.

The objects and advantages of the present invention will be further appreciated in light of the following detailed description and drawings in which:

### BRIEF DESCRIPTION OF THE DRAWINGS

FIG. 1 is a prospective view of a ticket according to the present invention.

FIG. 2 is a perspective view of a ticket in use.

FIG. 3A is a cross-sectional view taken on Line 3A-3A of FIG. 1.

FIG. 3B is a cross-sectional view partially in disassemble similar to FIG. 3A.

FIG. 3C is a cross-sectional view taken on Line 3C-3C of FIG. 2.

FIG. 4 is a diagrammatic depiction of the apparatus used to produce the tickets shown in FIGS. 1-3C.

### DETAILED DESCRIPTION

The present invention is an admission ticket 12 which can be typically used for admission to any event such as a sporting event, concert, fair or the like. Generally for use in the present invention the ticket will be an advance purchase ticket which is an admission ticket purchased prior to the event.

As with most admission tickets, the admission ticket 12 includes an admission stub 14 and a ticket stub 16 separated by a perforation line 18. The admission stub 14 is kept by the purchaser of the ticket and the ticket stub 16 is separated from the ticket at the gate and retained by the ticket taker.

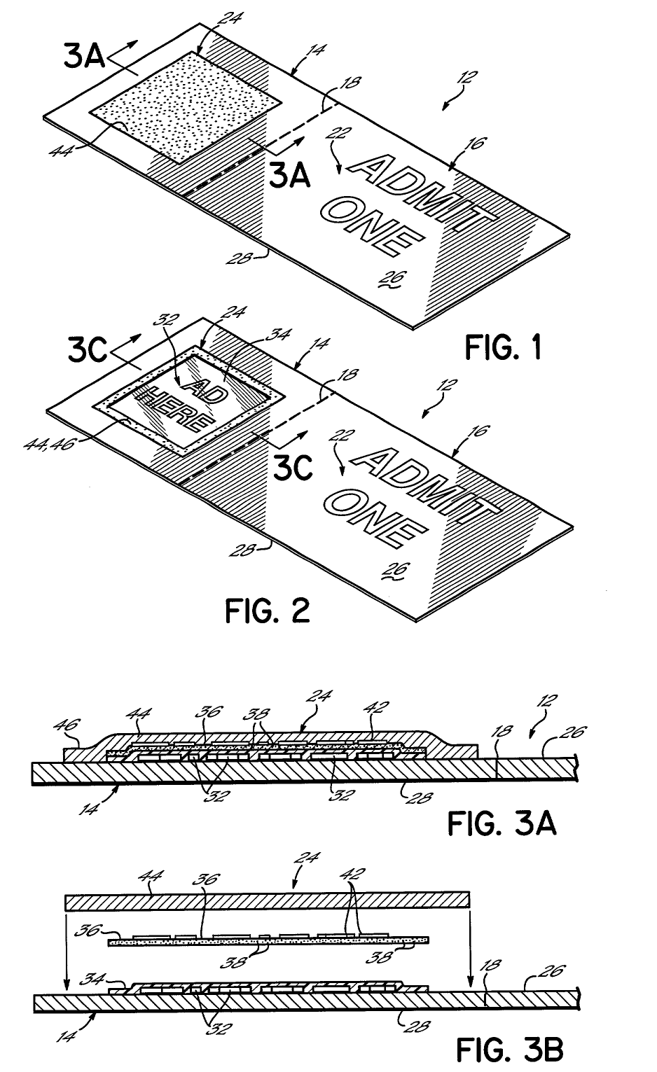

As shown, the admission ticket 12 in FIGS. 1-3C includes indicia 22 which indicates that it would admit one and further includes a section referred to as an ad area 24. The ad area 24 can either be on the front side 26 of the ticket or the back side 28 of the ticket. For use in the present invention, the ad area is defined by a scratch-off coating which conceals indicia potentially entitling the bearer of the ticket stub 14 to some prize such as buy one-get one free, a free soft drink or the like or perhaps, “sorry, try again”.

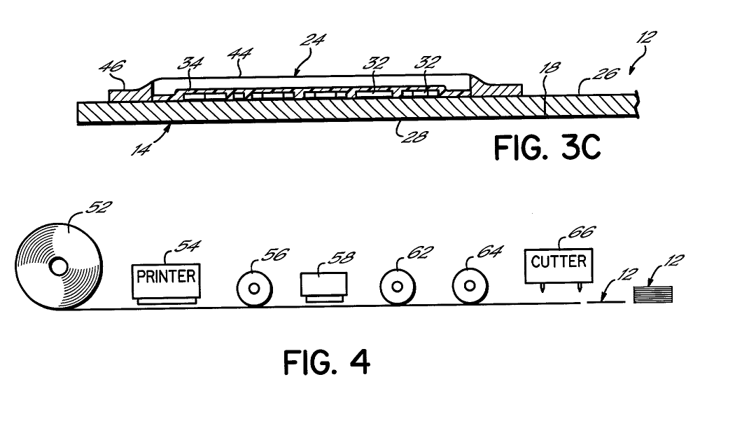

The ad area 24 includes the indicia layer 32 which will generally vary from ticket to ticket. This in turn is covered with a sealant layer 34 if necessary depending on the paper stock used. This is in turn covered by a release layer 36 which incorporates contrasting particles 38. Covering the release layer 36 is a confusion coating 42 followed by an opaque ink layer 44. The opaque ink layer 44 is larger than the release layer 36 so that a portion 46 of the opaque coating is permanently bonded to an area bordering the ad area which in effect leaves border 46 that cannot be removed as best shown in FIGS. 2 and 3C.

More particularly, the ticket 12 is formed from ticket stock. With certain stocks i.e., tab stock, the release layer absorbs into the paper creating the need for the sealing layer 34. Otherwise the release layer 36 is ineffective.

The indicia 32 in the ad area 24 is preferably variable indicia. In other words, different tickets will have different indicia. One ticket may indicate the bearer is entitled to a free soft drink while another might indicate the bearer is entitled to a sandwich. This indicia 32 is printed utilizing a printing apparatus such as an ion deposition unit which allows the printer to change the indicia printed on each ticket. This is typically a laser-type printer. Such ion deposition units can be purchased, for example, from Delfax.

The optional sealing layer 34 is applied using a flexographic printer and is simply a polymeric varnish. Such materials can be purchased for example from Craig Adhesive and Radcure. The sealant 34 should cover the entire ad area 24. The particular sealant layer is not important for use in the present invention. The sealant layer is generally about 0.001″ thick. The sealant can incorporate an anti-counterfeiting feature such as a UV optical brightener. The UV optical brightener permits counterfeit detection by making this portion of the ad area shine when exposed to a UV light. These are commercially available.

The release coat 36 again is a commercially available product. This is a varnish with a high proportion of wax. Such release coating can be purchased from for example Craig Adhesive or Radcure under the brand name. This coating is preferably modified prior to the application by incorporating therein contrasting particulate material. The particulate material 38 must be small enough so that it can be applied utilizing the flexographic rollers which have tiny cells which fill with the coating composition and deposit onto the ad area 24. Typically these cells have a diameter of about 0.032 inches. Therefore it is preferred to have a particulate material 38 that is significantly smaller than this with about 0.004 inches diameter particles preferred.

These particles 38 can be a wide variety of different particles such as metal particles, glass, UV brightened particles, inorganic grit, magnetic particles, basically any particulate material that will not dissolve in the release coating and is easily detectable. One material which is preferred is metallic glitter which has a particle size of about 0.004. This can be purchased from any glitter manufacturer such as Jones Tones.

The particulate material is generally blended with the release coating 36. Approximately 15% by weight of the particulate material 38 is added to the release coating and blended at high RPM, approximately 650 RPM for about 20 minutes. This is then allowed to sit for 12 hours forming a stable emulsion which can be applied using the printing apparatus. The release coating is applied over the sealant covering the ad areas or directly over the ad area. The sealant layer 34 will generally be about 0.002″ thick.

Next an optional confusion coating 12 can be printed over the release coating 36. This simply can be any type of pattern which would prevent one from seeing through the ink coating 42, determining in advance the underlying indicia 32. This is optional and frequently not required in the present invention. This is simply applied using a flexographic printer.

Finally the opaque ink 44 overcoats the ad area 24. The ink can also be purchased from Radcure and generally it is a metallic ink such as silver or the like. This is applied in a coating thickness from about 0.001″. The size of the opaque ink coating 42 will be dimensionally larger at some area or will extend beyond the release coating 36. As shown, the opaque ink coating 42 is approximately ⅛″ wider on all sides relative to the release coating 36. This provides a border area 46 that is applied directly to the paper stock. This is a permanent border area which cannot be scratched off without destroying the ticket itself. The border 46 area can take on any design. Further if the release 36 coating is applied as a non-continuous design, the opaque ink 44 will remain as the negative of that design. The remaining portion of the opaque ink covers the release area 36 and can be easily scratched off leaving behind the ink which is applied to any portion not covered with the release coating.

As shown in FIG. 4, the tickets 12 of the present invention are formed from a roll 52 of stock material which passes through the ion deposition unit 54 which will print indicia 32 (see FIG. 3A) on the front or back side of material 52 and can change the indicia 32 printed on each ticket. The stock material 52 then passes through a sealer unit 56 (if needed) where a flexographic printer applies sealant 34 (FIG. 3A) to the printed portion 32. Next a second flexographic unit 58 is used to apply release coating 36 which incorporates the release coating and preferably the metallic particles 38. A third flexographic unit 62 applies the confusion coating 42 (FIG. 3A) over the release coating 36. As indicated, this is optional. Finally the last printer 64 applies is the opaque ink 44 over the ad area 24 and slightly outside of the ad area. Stock material 52 passes through a cutter-perforator 66 which cuts the stock into individual tickets and provides perforation 18 to separate the admission stub 16 from the ticket stub 14.

The present invention provides a wide variety of advantages. The use of the metallic particles in the release coating deters illegal duplication of the ticket. Further simply having a scratch-off portion for an admission ticket itself prevents unauthorized duplication of the ticket. Thus, the ticket taker can readily discern that the ticket has a scratch-off portion and use this to authenticate the ticket. Further, by making this opaque coating larger than the release coating, a permanent opaque mark is provided on the ticket which prevents duplication of the ticket even if the scratch-off portion is already removed.

Utilizing the present invention with a scratch-off area for a back-ad further enhances the perceived value of the ad coupon regardless of the use of the scratch-off area for ticket authentication. Thus simply having a scratch-off portion that conceals an ad coupon will increase the perceived value by the ticket holder and increase the advertising value of that ticket. Further the addition of the metallic particles to the opaque ink provides an aesthetic appearance that enhances the ticket itself. Thus, the present invention provides a variety of different advantages and the invention itself should be defined only by the appended claims wherein

We claim:

1. An advance purchase ticket said ticket having a scratch-off area said scratch-off area having at least one anti-counterfeiting measure.

2. The ticket claimed in claim 1 wherein said scratch-off area includes an indicia layer covered with a release layer in turn covered with an opaque ink layer.

3. The ticket claimed in claim 2 wherein said anti-counterfeiting measure comprises contrasting particulate matter provided in said release layer.

4. The ticket claimed in claim 3 wherein said opaque ink layer covers said release layer and a portion of said ticket which is not covered by said release layer whereby said ink which is applied to said portion is permanently bonded to said ticket providing said anti-counterfeiting measure.

5. The ticket claimed in claim 4 wherein said portion borders said release layer.

6. The ticket claimed in claim 3 wherein said anti-counterfeiting measure comprises an optical brightener included between said indicia and said opaque ink coating.

7. A method of authenticating advance purchase tickets comprising providing a scratch-off area on said ticket whereby said scratch-off area comprises an opaque ink coated over a portion of said ticket with a release layer intermediate said ticket and said opaque ink coating and detecting said scratch-off area at an admission entrance.

8. A method of advertising comprising printing variable ads on a plurality of admission tickets wherein at least some of said variable ads provide an indication of value;
coating said ads with a scratch-off coating.

9. The method claimed in claim 8 wherein said scratch-off coating is provided with an anti-counterfeiting feature.

10. The method claimed in claim 9 wherein said scratch-off coating comprises multiple layers and said anti-counterfeiting feature comprises incorporating an optical brightener into at least one layer of said scratch-off coating.

11. The method claimed in claim 9 wherein said scratch-off coating comprises multiple layers and said anti-counterfeiting feature comprises incorporating contrasting particles into at least one layer of said scratch-off coating.

12. The method claimed in claim 9 wherein said scratch-off coating includes a release layer and an opaque ink layer and said anti-counterfeiting feature comprises providing said release coating over at least a portion of said ad and coating said release coating with said opaque ink wherein said ink covers said release coating and a portion of said ticket which is not covered with said release coating whereby said ink is permanently bonded to said ticket at said portion.
